(19) United States
(12) Patent Application Publication
(10) Pub. No.: US 2015/0246433 A1
(43) Pub. Date: Sep. 3, 2015

(54) UNIVERSAL PLIER STRUCTURE

(71) Applicant: LI-TU WU, Taichung city (TW)

(72) Inventor: LI-TU WU, Taichung city (TW)

(21) Appl. No.: 14/192,869

(22) Filed: Feb. 28, 2014

(51) Int. Cl. B25B 7/22; B25B 7/18

(52) U.S. Cl. CPC B25B 7/22; B25B 7/18

(57) ABSTRACT

A universal plier structure contains: a first handle, a second handle, a first extending arm, a second extending arm, and an adjusting member. The first extending arm is disposed on the first handle and includes a first orifice, the second extending arm is mounted on the second handle and includes a connecting extension overlapping with the first orifice, and the connecting extension has a second orifice corresponding to the first orifice. The first extending arm also includes a first cutting face defined thereon, the second extending arm also includes a second cutting face defined on a peripheral side thereof and corresponding to the first cutting face, the adjusting member is defined between the first handle and the second handle and is used to adjust a distance between the first handle and the second handle so as to change a distance between the first extending arm and the second extending arm.

### FIELD OF THE INVENTION

The present invention relates to a universal plier structure in which a distance between a first extending arm and a second extending arm is adjusted, and the first extending arm and the second extending arm are connected together at a connection position so as to enhance a clamping precision of the first extending arm and the second extending arm, thus sharpening a cutting structure.

### BACKGROUND OF THE INVENTION

A conventional universal plier is disclosed in TW Patent No. M449066 and contains a fixed clamping arm including a first handle and a fixed head portion connecting with the first handle; a movable clamping arm including a second handle opposite to the first handle and a movable head portion coupled with the second handle and the fixed clamping arm and driven by the second handle so as to move relative to the fixed head portion; a locking unit including a limiting member joining with the second handle of the movable clamping arm and extending toward the first handle of the fixed clamping arm; and an adjusting unit including a screw rod screwing with the first handle of the fixed clamping arm and abutting against the limiting member of the locking unit, the adjusting unit also including an adjustable knob coupling with the screw rod. The adjustable knob has an operating block connected with the screw rod, and the operating block has an upper peripheral fringe and a lower peripheral fringe which are provided to define an outer peripheral face. The outer peripheral face has a recess defined between the upper peripheral fringe and the lower peripheral fringe.

However, two cutting faces of the fixed clamping arm and the movable clamping arm of the conventional plier cannot aligned with each other precisely, thus causing poor cutting effect.

The present invention has arisen to mitigate and/or obviate the afore-described disadvantages.

### SUMMARY OF THE INVENTION

The primary objective of the present invention is to provide a universal plier structure in which a distance between a first extending arm and a second extending arm is adjusted, and the first extending arm and the second extending arm are connected together at a connection position so as to enhance a clamping precision of the first extending arm and the second extending arm, thus sharpening a cutting structure.

To obtain the above objective, a universal plier structure provided by the present invention contains: a first handle, a second handle, a first extending arm, a second extending arm, and an adjusting member.

The first extending arm is disposed on one end of the first handle and includes a first orifice, the second extending arm is mounted on one end of the second handle and includes a connecting extension extending outwardly from one end thereof so as to overlap with the first orifice, and the connecting extension has a second orifice defined thereon and corresponding to the first orifice.

The first extending arm also includes a first cutting face defined on a predetermined section of a peripheral side thereof, and the second extending arm also includes a second cutting face defined on a predetermined section of a peripheral side thereof and corresponding to the first cutting face, the adjusting member is defined between the first handle and the second handle and is used to adjust a distance between the first handle and the second handle so as to change a distance between the first extending arm and the second extending arm.

### BRIEF DESCRIPTION OF THE DRAWINGS

FIG. 1 is a perspective view showing the exploded components of a universal plier structure according to a first embodiment of the present invention.

FIG. 2 is a perspective view showing the assembly of the universal plier structure according to the first embodiment of the present invention.

FIG. 3 is a cross sectional view showing the assembly of the universal plier structure according to the first embodiment of the present invention.

FIG. 4 is another cross sectional view showing the assembly of the universal plier structure according to the first embodiment of the present invention.

FIG. 5 is a cross sectional view showing the assembly of the puller structure according to a second embodiment of the present invention.

FIG. 6 is a perspective view showing the assembly of the universal plier structure according to a third embodiment of the present invention.

FIG. 7 is a perspective view showing the assembly of the universal plier structure according to a fourth embodiment of the present invention.

### DETAILED DESCRIPTION OF THE PREFERRED EMBODIMENTS

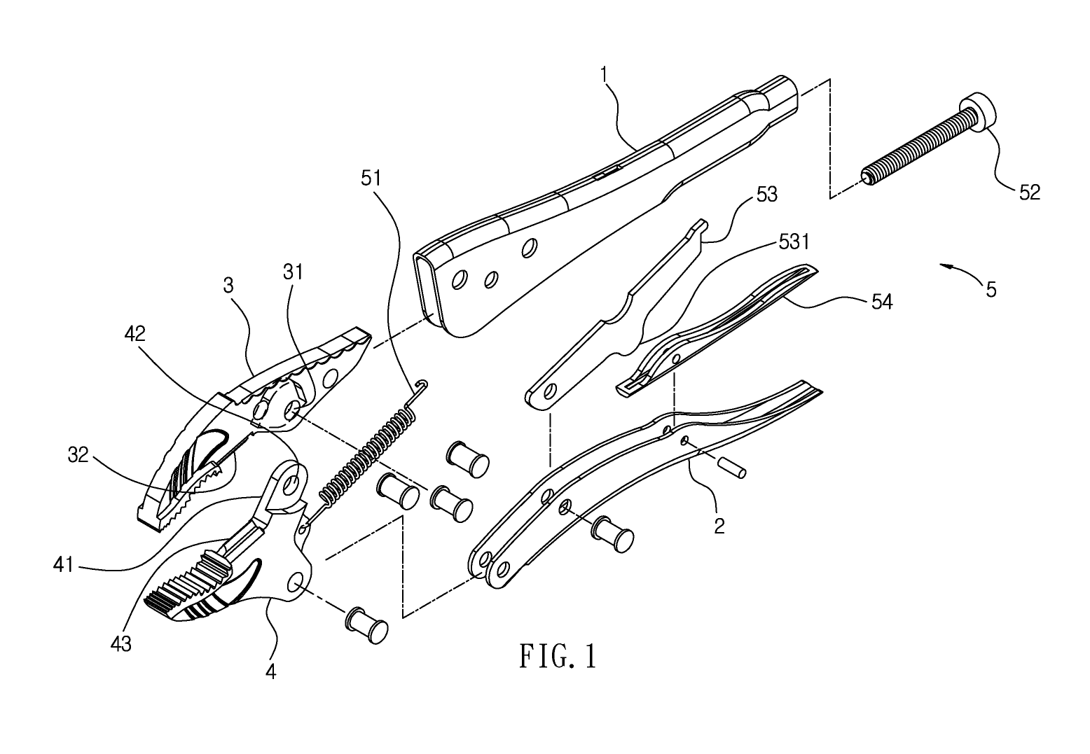

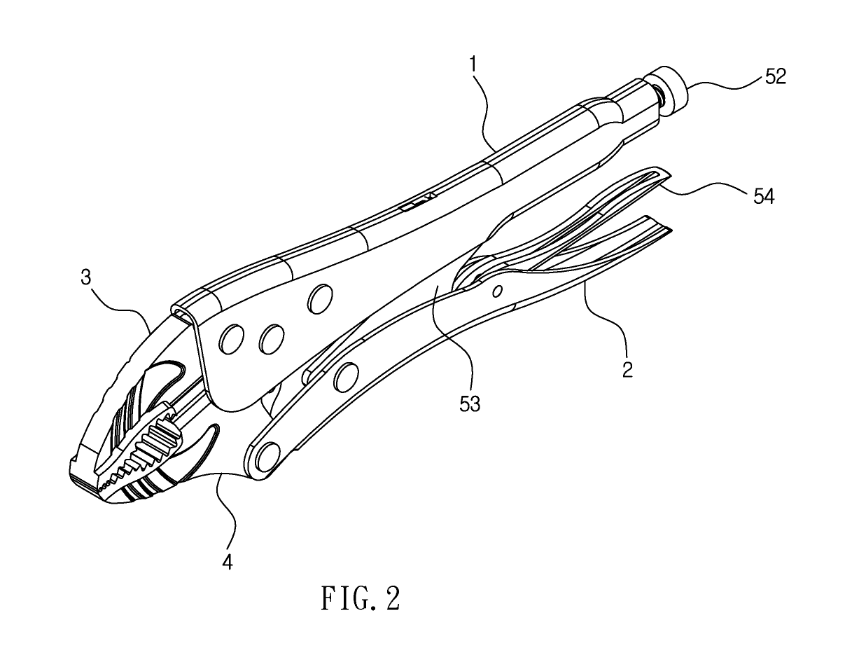

With reference to FIGS. 1-4, a universal plier structure according to a first embodiment of the present invention comprises: a first handle 1, a second handle 2, a first extending arm 3, a second extending arm 4, and an adjusting member 5.

The first extending arm 3 is disposed on one end of the first handle 1 and includes a first orifice 31, the second extending arm 4 is mounted on one end of the second handle 2 and includes a connecting extension 41 extending outwardly from one end thereof so as to overlap with the first orifice 31, and the connecting extension 41 has a second orifice 4 defined thereon and corresponding to the first orifice 42.

The first extending arm 3 also includes a first cutting face 32 defined on a predetermined section of a peripheral side thereof, and the second extending arm 4 also includes a second cutting face 43 defined on a predetermined section of a peripheral side thereof and corresponding to the first cutting face 32. The adjusting member 5 is defined between the first handle 1 and the second handle 2 and is used to adjust a distance between the first handle 1 and the second handle 2 so as to change a distance between the first extending arm 3 and the second extending arm 4.

Since an overlapping portion forms between the first extending arm 3 and the second extending arm 4, a clamping tolerance of the first extending arm 3 and the second extending arm 4 is reduced so as to enhance an alignment accuracy of the first cutting face 32 and the second cutting face 43.

The adjusting member 5 includes a spring 51, an adjustable screw rod 52, a driving piece 53, and a releasing post 54. The spring 51 has a first end hooking with a bottom edge of the second extending arm 4 and defined between the first extending arm 3 and the second handle 4 and has a second end inserted into an accommodating chamber of the first handle 1 and hooking with a middle portion of the accommodating chamber thereof. The driving piece 53 has a front end connecting with two inner walls of the second handle 2 and has a rear end inserted between the two inner walls of the second handle 2. The adjustable screw rod 52 is screwed with a bottom end of the first handle 1 and used to push the driving piece 53. The driving piece 53 also includes a guiding rib 531 extending to the second handle 2 from a middle section of a bottom end thereof. The releasing element 54 is coupled with the two inner walls of the second handle 2 and has a first end pushed by the guiding rib 531 and a second end swinging after its first end is pushed by the guiding rib 531.

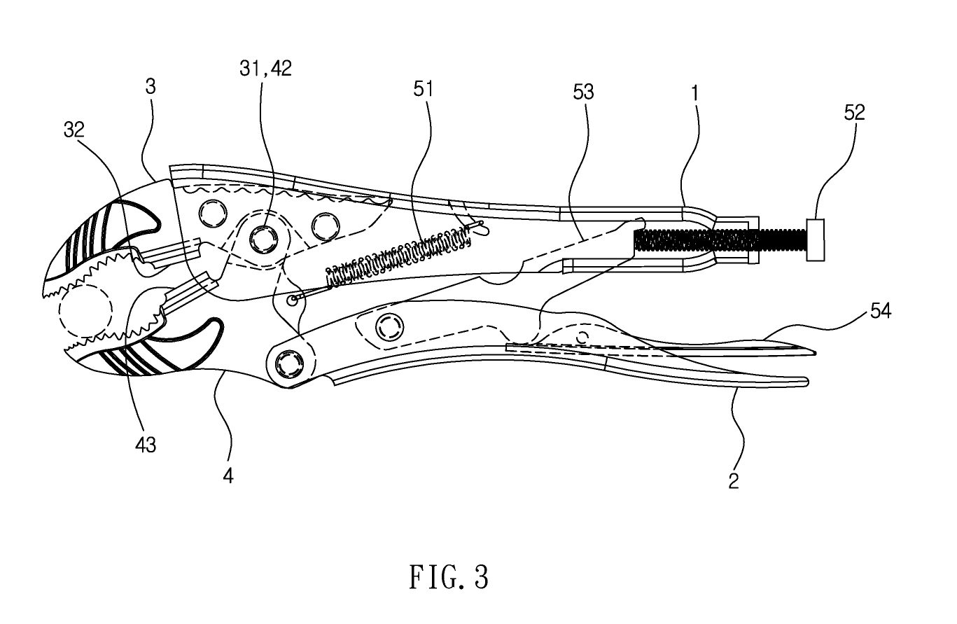

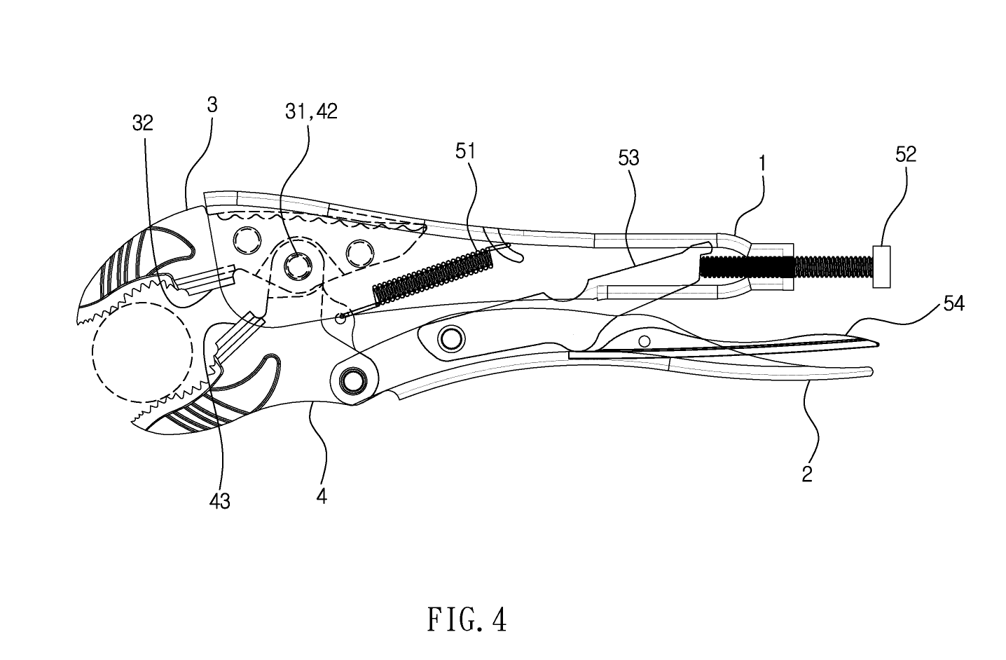

Referring to FIGS. 3 and 4, when adjusting the distance between the first extending arm 3 and the second extending arm 4, the adjustable screw rod 52 is rotated so as to push or release the driving piece 53. For example, when the adjustable screw rod 52 pushes the driving piece 53, the driving piece 53 pushes the second handle 2 and the second extending arm 4 to rotate relative to the first extending arm 3 (in the meantime, the spring 51 is pushed by the second extending arm 4), such that the first extending arm 3 and the second extending arm 4 move to each other (as shown in FIG. 3), thereby retracting the first extending arm 3 and the second extending arm 4. When the adjustable screw rod 52 releases the driving piece 53, the spring 51 pushes the second handle 2 and the second extending arm 4 to rotate reversely relative to the first extending arm 3, such that the first extending arm 3 and the second extending arm 4 move away from each other, thereby expanding the first extending arm 3 and the second extending arm 4 (as shown in FIG. 4).

Furthermore, after the first handle 1 and the second handle 2 are pressed, the driving piece 53 is driven to press the second handle 2, hence the first extending arm 3 and the second extending arm 4 clamp an object. Thereafter, the releasing element 54 reversely pushes the guiding rib 531 to release a clamping to the object. Since such a clamping manner is well known, further remarks are omitted.

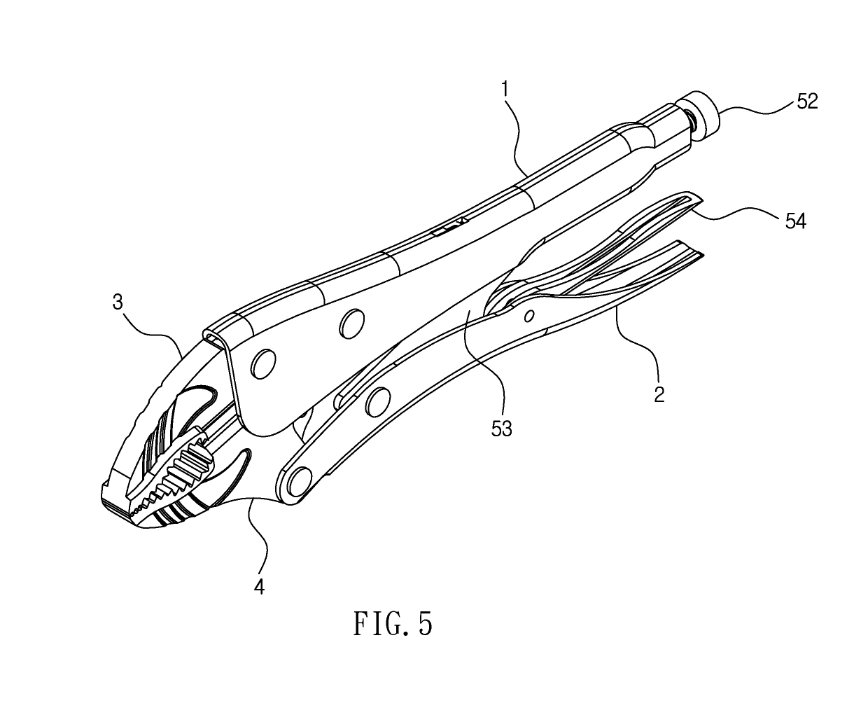

As shown in FIG. 5, a universal plier structure according to a second embodiment of the present invention comprises: a first orifice 31 and a second orifice 42. The first orifice 31 and the second orifice 42 are connected with a first handle 1 by ways of a first riveting element. Due to a first extending arm 3 is locked with the first handle 1 by two second riveting elements, the first orifice 31 and the second orifice 42 are connected together firstly, and then the first extending arm 3 is locked with the first handle 1, such that a riveting position on the first handle 1 is removed, thus obtaining aesthetics appearance.

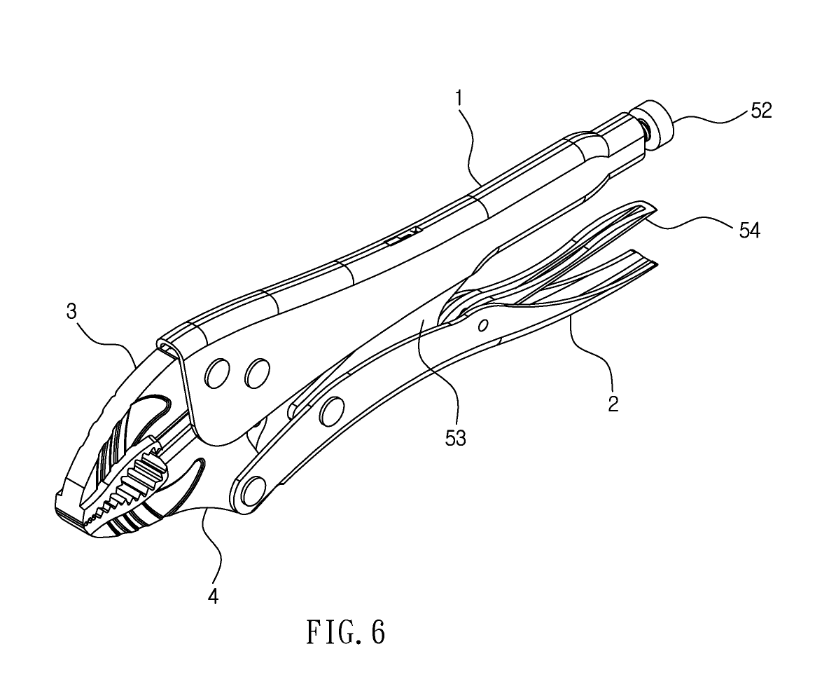

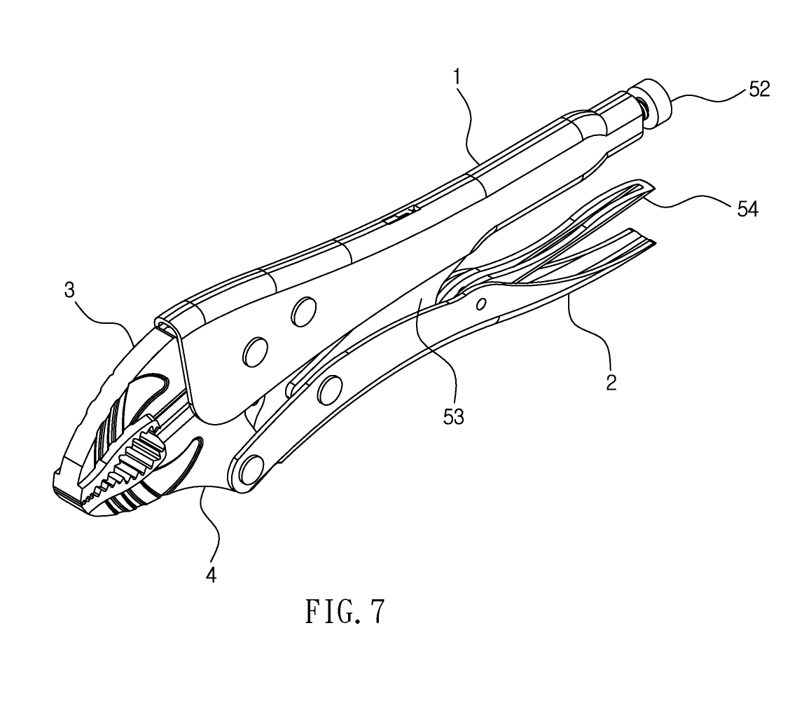

In addition, FIGS. 6 and 7 show the universal plier structure of various riveting positions according to a third embodiment and a fourth embodiment of the present invention.

Thereby, the distance between the first extending arm and the second extending arm is adjusted, and the first extending arm and the second extending arm are connected together at a connection position so as to enhance a clamping precision of the first extending arm 3 and the second extending arm 4, thus sharpening a cutting structure.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A universal plier structure comprising: a first handle, a second handle, a first extending arm, a second extending arm, and an adjusting member;
wherein the first extending arm is disposed on one end of the first handle and includes a first orifice, the second extending arm is mounted on one end of the second handle and includes a connecting extension extending outwardly from one end thereof so as to overlap with the first orifice, and the connecting extension has a second orifice defined thereon and corresponding to the first orifice;
the first extending arm also includes a first cutting face defined on a predetermined section of a peripheral side thereof, and the second extending arm also includes a second cutting face defined on a predetermined section of a peripheral side thereof and corresponding to the first cutting face, the adjusting member is defined between the first handle and the second handle and is used to adjust a distance between the first handle and the second handle so as to change a distance between the first extending arm and the second extending arm.

2. The universal plier structure as claimed in claim 1, wherein the adjusting member includes a spring, an adjustable screw rod, a driving piece, and a releasing post; the spring has a first end hooking with a bottom edge of the second extending arm and defined between the first extending arm and the second handle and has a second end inserted into an accommodating chamber of the first handle and hooking with a middle portion of the accommodating chamber thereof; the driving piece has a front end connecting with two inner walls of the second handle and has a rear end inserted between the two inner walls of the second handle; the adjustable screw rod is screwed with a bottom end of the first handle and is used to push the driving piece; the driving piece also includes a guiding rib extending to the second handle from a middle section of a bottom end thereof; the releasing element is coupled with the two inner walls of the second handle and has a first end pushed by the guiding rib and a second end swinging after its first end is pushed by the guiding rib.
